(19) United States
(12) Patent Application Publication
(10) Pub. No.: US 2006/0073303 A1
(43) Pub. Date: Apr. 6, 2006

(54) Flinger disc

(75) Inventors: Heinz P. Bloch, West Des Moines, IA (US); Rojean M. Thomas, Mukwonago, WI (US); Dan E. Freeland, West Allis, WI (US); Jeff T. Malinowski, Hartford, WI (US)

Correspondence Address: RYAN KROMHOLZ & MANION, S.C., POST OFFICE BOX 26618, MILWAUKEE, WI, 53226, US

(73) Assignee: Trico Mfg. Corp.

(21) Appl. No.: 10/957,876

(22) Filed: Oct. 4, 2004

(51) Int. Cl. B32B 3/02

(52) U.S. Cl. 428/66.6

(57) ABSTRACT

To achieve proper lubrication, a bearing housing or reservoir is filled with a predetermined amount of lubricant. When the machine, of which a bearing is a component, is operated, a flexible flinger disc provides proper lubrication by disturbance of the lubricant.

### BACKGROUND OF THE INVENTION

Lubrication is an important aspect of maintaining machinery in proper operating condition. Machine elements such as bearings, journals, shafts, and joints require proper lubrication between their moving surfaces to decrease friction, prevent contamination, reduce wear and dissipate heat. Improper lubrication is likely to lead to premature component wear and component or system failure.

When determining the optimal lubrication between moving machine elements, many factors should be considered. These factors include the mode of operation of the machine, the type of machine element to be lubricated, the environment of the machine, the operating speed of the machine, the lubricant's viscosity, the lubricant's temperature, the lubricant's ingredients, and the lubricant's condition.

Prior art lubricators, such as the TRICO OptoMatic oiler, supply a constant level of lubricant within a lubricant reservoir to a machine element. The lubricant level is predetermined for the particular application and cannot be changed during the operating time of the machine to which the constant level lubricator is attached. Although this type of lubricator provides reasonable performance in many steady-state operations, multiple variables can create unacceptable operating conditions and lead to premature wear, or even failure, of machine elements. The variables include “on” and “off” operating modes (machine cycling), oil viscosity, machine speed, lubricant temperature, lubricant condition, and lubricant vessel pressure.

Other devices, such as the TRICO Hydrolert indicate by LED signals the status of the equipment's lubrication such as lubricant condition within acceptable levels, lubricant condition at the upper limit of acceptable levels, and lubricant condition immediate action required. This device is effective because an operator is signaled only when the lubricant condition is at the upper limit of acceptable levels or if immediate action is required. This reduces maintenance costs and productivity is enhanced.

There are various means that different pump manufacturers are using for lubricating bearings within a pump. The three most common are: 1) oil bath/splash 2) pure oil mist and 3) purge oil mist. Oil bath/splash is the most common means of lubricating the bearings.

Oil splash typically occurs by 3 different ways: 1) oil level is at the bottom of the bearing roller elements resulting in continuous contact with the oil 2) oil level is below bearings, and oil rings are used to splash oil to top of bearing or 3) oil level is either at or slightly below bearings and Flinger discs are used to splash oil. For pure oil mist systems, no flingers or rings are used. For purge oil mist systems, flingers, oil rings may be used in conjunction with mist system.

What method the pump manufacturer uses for lubricating the bearings depends on speed as well as various other various factors that affect the overall temperature.

The purpose of either a flinger disc or oil ring is 1) to provide lubricant to the bearing and 2) prevent thermal stratification of the oil (hot/cold).

Traditional flinger discs are limited in diameter by the design of the housing. Oil rings generally are capable of dipping further into the oil bath. An oil ring is typically equal to 1.6 times the diameter of the shaft.

Below are some cross sections from different pump manufacturers showing the different types of design for Oil splash.

[image]

### SUMMARY OF THE INVENTION

The flinger disc of the present invention comprises a disk that is flexible during installation and allows for submersion into the oil bath, as the traditional oil ring does. The ring can comprise polypropylene, but preferably Viton™, or other oil compatible and resistant material.

In a preferred embodiment, the thickness of the disc is roughly 1/16″ to 3/32″ and submerses in the oil bath about ⅜″. The flinger disc preferably has a steel hub to maintain concentricity and be positively secured to the shaft.

Also in a preferred embodiment, grooves are molded into the either Viton™ or flexible plastic disc portion at different diameters to allow for flexibility. Scissors can be used to cut out the required diameter and adjust the level of submersion into the oil.

Perceived advantages of the present invention comprise a reduction in temperature; increased bearing life; increased lubrication life; possibility to run at higher speeds; reduction in required oil level; maintain bearing life while consuming less oil; reduction in energy costs; elimination of contamination by wearing of Oil rings. Additionally, the flinger disc of the present invention advantageously provides: 1) same submersion level in oil as oil rings 2) not sensitive to horizontality; 3) not sensitive to wear and 4) easier assembly and disassembly of pump drive end.

### BRIEF DESCRIPTION OF THE DRAWINGS

FIG. 1. is a side view, with portions broken away, of the workpiece to which the flinger disk of the present invention is advantageously applied.

FIG. 2 is a side view, with portions broken away, of a flinger disk being installed into the workpiece.

FIG. 3 is a perspective view of the flinger disk of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention.

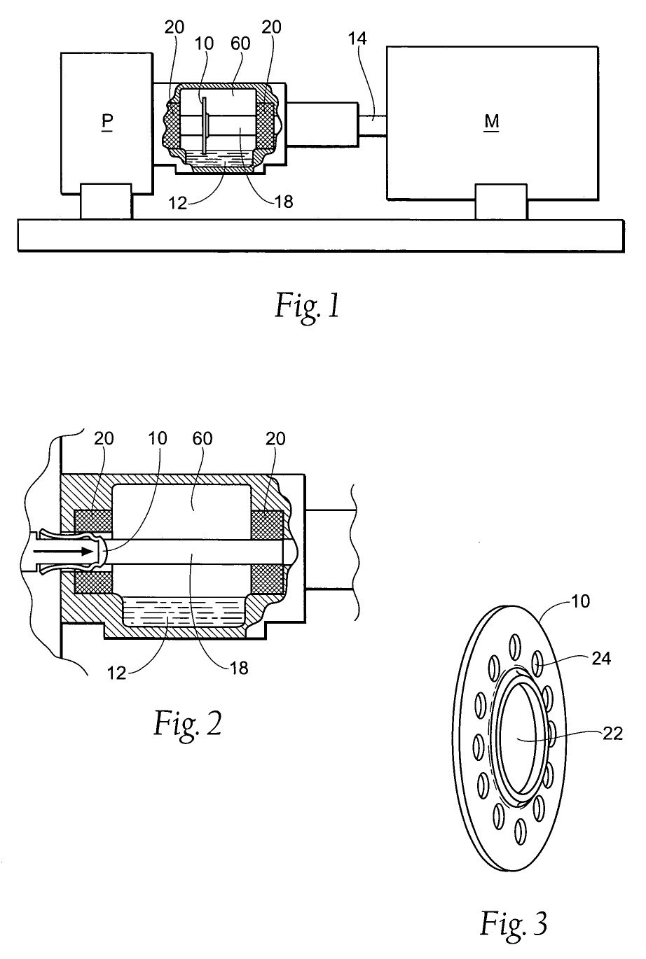

Referring now to FIG. 1., a side view, with portions broken away, of the workpiece to which the flinger disk of the present invention is advantageously applied is shown, although the invention can be applied in different work environs. In FIG. 1, the workpiece is shown as a centrifugal pump P with a motor M. The invention provides an optimal lubrication condition to machine element or bearings 20 by providing a flinging of the lubricant 12, such as oil. In FIG. 1, the bearings 20 are viewed from the side, with their front profile generally doughnut shaped. The lubricant 12 is contained within a fluid reservoir, or bearing housing 60. Typically, two bearings 20 are located within the bearing housing 60. Bearing 20 includes an inner race, an outer race, and a plurality of rolling ball elements positioned between inner race and outer race (not shown). In order for bearing 20 to perform its function of maintaining a low friction precision relationship between a rotating element or shaft 18 and bearing housing 60, the bearing 20 must operate in an environment where it receives proper lubrication.

To achieve proper lubrication, bearing housing or reservoir 60 is filled with a predetermined amount of lubricant 12. When the machine, of which bearing 20 is a component, is in a static state, the amount of lubricant 12 within the housing 60, the pressure of the lubricant 12, the distribution of the lubricant 12 within the housing 60, and the temperature of the lubricant 12 are constant.

The polyurethane flinger disc of the present invention is installed on the shaft as shown in FIGS. 1 and 2.

To test the efficacy of the present invention, a quantity of four thermal couples were installed, 1) bottom of sump 602) near the bearing 20 3) at top near the flinger disc 10 and 4) at the side port where the flinger disk 10 is shown in FIG. 2. A total of 16 different scenarios were tested varying oil level, type of oil and speed of pump. Each test was run for an 8 hour time period with continuous temperatures being recorded at each thermocouple. Synthetic 68 weight oil was tested first due to availability but all other tests represent mineral oil.

Test Results

Below are charts outlining the test results for the 16 different 8 hour tests that were ran.

| | Max temp. per sensor | | | | Max |
|---|---|---|---|---|---|
| | | Bear- | Fling- | Side | temp |
| Set up | Bottom | ing | er | port | average |
| Flinger disc ISO 32 | 96.8 | 96.7 | 96.8 | 96.3 | 96.7 |
| 1800 rpm Oil @ | | | | | |
| CL bearing | | | | | |
| Flinger disc ISO 32 | 92.5 | 92.3 | 92.9 | 95 | 93.2 |
| 1800 rpm Oil @ ⅜″ | | | | | |
| below CL bearing | | | | | |
| No disc ISO 32 | 81 | 84.2 | 83.3 | 83.3 | 83.0 |
| 1800 rpm Oil @ | | | | | |
| CL bearing | | | | | |
| Flinger disc ISO 32 | 97.2 | 96.8 | 96.7 | 96.85 | 96.9 |
| 3600 rpm Oil @ | | | | | |
| CL bearing | | | | | |
| Flinger disc ISO 32 | 90 | 91.4 | 91.1 | 95.4 | 92 |
| 3600 rpm Oil @ ⅜″ | | | | | |
| below CL bearing | | | | | |
| No disc ISO 32 | 91.8 | 100.8 | 96.5 | 102.4 | 97.9 |
| 3600 rpm Oil @ | | | | | |
| CL bearing | | | | | |
| Flinger disc ISO 68 | 96.7 | 95.2 | 96.1 | 96.7 | 96.2 |
| (syn) 1800 rpm Oil @ | | | | | |
| CL bearing | | | | | |
| Flinger disc ISO 68 | 95.9 | 95.2 | 95.6 | 95 | 95.4 |
| (min) 1800 rpm Oil @ | | | | | |
| CL bearing | | | | | |
| Flinger disc ISO 68 (syn) | 88.9 | 89.6 | 93.4 | 90.9 | 90.7 |
| 1800 rpm Oil @ ⅜″ | | | | | |
| below CL bearing | | | | | |
| Flinger disc ISO 68 (min) | 94.5 | 95.9 | 101 | 101.5 | 98.2* |
| 1800 rpm Oil @ ⅜″ | | | | | |
| below CL bearing* | | | | | |
| No disc ISO 68 (min) | 87.7 | 90.3 | 89.8 | 91.1 | 89.7 |
| 1800 rpm Oil @ CL | | | | | |
| bearing | | | | | |
| Flinger disc ISO 68 (syn) | 104.8 | 104.6 | 105.1 | 104.9 | 104.9 |
| 3600 rpm Oil @ | | | | | |
| CL bearing | | | | | |
| Flinger disc ISO 68 (min) | 105.5 | 104.2 | 105.5 | 104.9 | 105.0 |
| 3600 rpm Oil @ | | | | | |
| CL bearing | | | | | |
| Flinger disc ISO 68 (syn) | 97 | 101.7 | 105.8 | 99.9 | 101.1 |
| 3600 rpm Oil @ ⅜″ | | | | | |
| below CL bearing | | | | | |
| Flinger disc ISO 68 (min) | 92 | 96.7 | 103.5 | 104.2 | 99.1 |
| 3600 rpm Oil @ ⅜″ | | | | | |
| below CL bearing | | | | | |
| No disc ISO 68 (min) | 93.1 | 98 | 97.6 | 103.5 | 98.1 |
| 3600 rpm Oil @ | | | | | |
| CL bearing | | | | | |

*note: flinger not touching oil due to cupping (see below)

| | Average Maximum Temperature | | |
|---|---|---|---|
| | | | Flinger |
| | No Disc | Flinger | w/Oil @ |
| | w/Oil @ CL | w/Oil @ CL | ⅜″ below CL |
| ISO 32 Mineral | | | |
| 1800 rpm | 83.0 | 96.7 | 93.2 |
| 3600 rpm | 97.8 | 96.9 | 92.0 |
| ISO 68 Mineral | | | |
| 1800 rpm | 89.7 | 95.4 | 98.2* |
| 3600 rpm | 98.1 | 105.0 | 99.1 |
| ISO 68 Synthetic | | | |
| 1800 rpm | Not ran | 96.2 | 90.7 |
| 3600 rpm | Not ran | 104.9 | 101.1 |

*During this test the flinger was not touching the oil consistently due to cupping.

A review of the results was completed and the 0.090″ thick Viton disc provided the best overall temperatures and durability.

The results show that the flinger disc would perform favorably when compared to typically oil ring applications where speeds tend to be 3,600 rpm.

The additional graphs below contain temperature readings for 0.090″ thick Viton disc with oil level below the bearings as compared to no disc and the oil in direct contact with the bearings.

[image]

[image]

The test results from the in-house lab testing are favorable with difference in temperatures observed being relatively small (+1-15%) between running with no disc and running with the flinger when the oil level is dropped below the bearing. When operating at 3600 rpm there is a more noticeable improvement resulting in improved performance of a Viton flinger disc over traditional oil ring applications.

Comments from Test Results:

The highest temperatures were observed when using the flinger disc 10 and when the bearings were in direct contact with the oil 12. This would be expected due to the additional heat generated from the flinger 10 dragging through the oil 12 as well as the bearing 20.
Test with 68 mineral oil @ 1800 rpm oil below centerline is not reflective due to cupping (see below) and not contacting the oil properly.
The flinger disc (with oil below bearing) performs better at the higher operating speed having the lowest operating temperature when using 32 wt. oil and is only 1 degree higher than no disc with the 68 wt oil.
As expected, higher temperatures occur when using a heavier weight oil.

The results show that the flinger disc 10 would perform favorably when compared to typically oil ring applications where speeds tend to be 3,600 rpm.

FIG. 2 is a side view, with portions broken away, of a flinger disk 10 being installed into the workpiece. Because the flinger disk 10 is of a flexible nature, it can be slid about the shaft 18 into the void space 60. The disk 10 is provided with a flexibility to bend the disk to a second cross-sectional area less than a first cross-sectional area, as shown, for insertion into a confined space.

FIG. 3 is a perspective view of the flinger disk 10 of the present invention. As can be seen, the flinger disk 10 is preferably provided with void spaces 24 to decrease weight.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

We claim:

1. A disk for insertion into an enclosed space; said disk comprising:
a non-metallic body having an outer diameter and a first cross-sectional area;
a hole through an interior region of said body;
said disk of a flexibility to bend to a second cross-sectional area less than said first cross-sectional area.
